(19) United States
(12) Patent Application Publication
(10) Pub. No.: US 2004/0167983 A1
(43) Pub. Date: Aug. 26, 2004

(54) WebDAV URL connection

(76) Inventors: Richard Friedman, Cherry Hill, NJ (US); Jason Kinner, Marlton, NJ (US); Joseph J. Snyder, Shamon, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/371,279

(22) Filed: Feb. 21, 2003

(51) Int. Cl. G06F 15/16

(52) U.S. Cl. 709/227

(57) ABSTRACT

A method for connecting a client with a WebDAV-compliant server over a HTTP channel is provided. The method comprises, at a Java™ Virtual Machine (JVM), configuring a WebDAV protocol handler for handling HTTP URL requests. The method further comprises invoking a WebDAV URL connection, allowing a client making a URL request to connect to a WebDAV-compliant server, connecting the client to the WebDAV-compliant server via the WebDAV URL connection; and allowing the connected client to execute WebDAV methods via the WebDAV URL connection.

### CROSS-REFERENCE TO RELATED APPLICATIONS

This application is related to co-pending, concurrently filed, and commonly assigned U.S. patent application Ser. No. ______ [Attorney Docket No. 100203190-1] entitled “XML DRIVEN WEBDAV UNIT TEST FRAMEWORK,” Ser. No. ______ [Attorney Docket No. 100202442-1] entitled “CONNECTING TO WEBDAV SERVERS VIA THE JAVA™ CONNECTOR ARCHITECTURE,” and Ser. No. ______ [Attorney Docket No. 100202438-1] entitled “WEBDAV UNIT TEST FRAMEWORK,” the disclosures of all of which are hereby incorporated herein by reference.

### BACKGROUND

Rich media is an Internet industry term for a Web page advertisement that uses advanced technology such as streaming video, downloaded applets (programs) that interact instantly with the user, and advertisements that change appearance and/or content when the user's cursor passes over them. The foundation of rich media architecture is the storage layer for digital assets, e.g., any digitally stored information. Providing an abstraction to the digital assets is the key to developing rich media-based applications and services. Defining this layer has the same importance as defining a common language and Application Programming Interfaces (APIs) for accessing traditional relational database systems. The storage layer comprises the asset, the metadata about the asset, and the structure to store this information. The storage layer has to provide expected features such as insert, update, delete and query.

Today, where and how to store digital assets, metadata, and the associations between them is a complex problem. Different applications can have vastly different requirements for storage. It is generally desirable to provide an abstract storage mechanism that will allow for heterogeneous storage for any or all of the above storage layer objects. Web-based Distributed Authoring and Versioning (WebDAV) is a protocol defined by the IETF RFC 2518 and is an extension of the HTTP protocol (RFC 2616). The WebDAV specification addresses the storage of all three types of object, and is currently in use in network storage solutions and web servers, as well as being supported in many authoring tools and in most operating systems.

Content management solutions, including editing functions such as read, write, delete, move, copy, etc., are a good fit for the storage requirements as well, and many already support WebDAV. In fact, WebDAV is divided into three separate specifications, each of which addresses particular storage operations: WebDAV (Web Distributed Authoring and Versioning), DASL (Searching and Locating), and Delta-V (Versioning). The WebDAV platform can also make it easier to add WebDAV capabilities to an existing Content Management System (CMS), in order to promote WebDAV technology.

### SUMMARY

In accordance with a first embodiment disclosed herein, a system operable to support Web-based Distributed Authoring and Versioning (WebDAV) protocol is provided. The system comprises a plurality of applications and server implementations, and a WebDAV URL connection operable to allow at least one application to have a raw WebDAV conversation with at least one server over a HTTP channel.

In accordance with another embodiment disclosed herein, a method for connecting a client with a WebDAV-compliant server over a HTTP channel is provided. The method comprises, at a Java™ Virtual Machine (JVM), configuring a WebDAV protocol handler for handling HTTP URL requests. The method further comprises invoking a WebDAV URL connection, allowing a client making a URL request to connect to a WebDAV-compliant server, connecting the client to the WebDAV-compliant server via the WebDAV URL connection; and allowing the connected client to execute WebDAV methods via the WebDAV URL connection.

In accordance with another embodiment disclosed herein, a system operable to support Web-based Distributed Authoring and Versioning (WebDAV) protocol is provided. The system comprises, at a Java™ Virtual Machine (JVM), means for configuring a WebDAV protocol handler for handling HTTP URL requests. The system further comprises means for invoking a WebDAV URL connection, means for allowing a client making a URL request to connect to a WebDAV-compliant server, means for connecting the client to the WebDAV-compliant server via the WebDAV URL connection, and means for allowing the connected client to execute WebDAV methods via the WebDAV URL connection.

In accordance with another embodiment disclosed herein, computer-executable software code stored to a computer-readable medium is provided. The computer-executable software code comprises code for configuring a WebDAV protocol handler for handling HTTP URL requests, code for invoking a WebDAV URL connection, code for allowing a client making a URL request to connect to a WebDAV-compliant server, code for connecting the client to the WebDAV-compliant server via the WebDAV URL connection, and code for allowing the connected client to execute WebDAV methods via the WebDAV URL connection.

### BRIEF DESCRIPTION OF THE DRAWING

FIG. 1 is a block diagram illustrating an overview of WebDAV system architecture according to the present embodiments;

FIG. 2 is a more detailed schematic block diagram illustrating the relationships between WebDAV Unit framework, HTTP Unit, WebDAV Compliance utility, and WebDAV server within the WebDAV system architecture. and

FIG. 3 is a flow diagram depicting the deployment of WebDAV URLConnection using WebDAV Protocol Handler, according to the present embodiments.

### DETAILED DESCRIPTION

A system and method are provided for connecting a client with a WebDAV-compliant server over a HTTP channel using a WebDAV URL connection. A Java™ Virtual Machine (JVM) configures a WebDAV protocol handler for handling HTTP URL requests. The WebDAV protocol handler invokes a WebDAV URL connection, which links a client to a WebDAV-compliant server and allows the connected client to execute WebDAV methods. In some embodiments, the JVM alternatively configures a HTTP protocol handler to handle normal HTTP traffic. In some embodiments, an application using the WebDAV protocol handler constructs valid XML requests to and/or parses XML responses from a WebDAV-compliant server. Alternatively, utilities running in a WebDAV Servlet package parse XML responses from a WebDAV-compliant server.

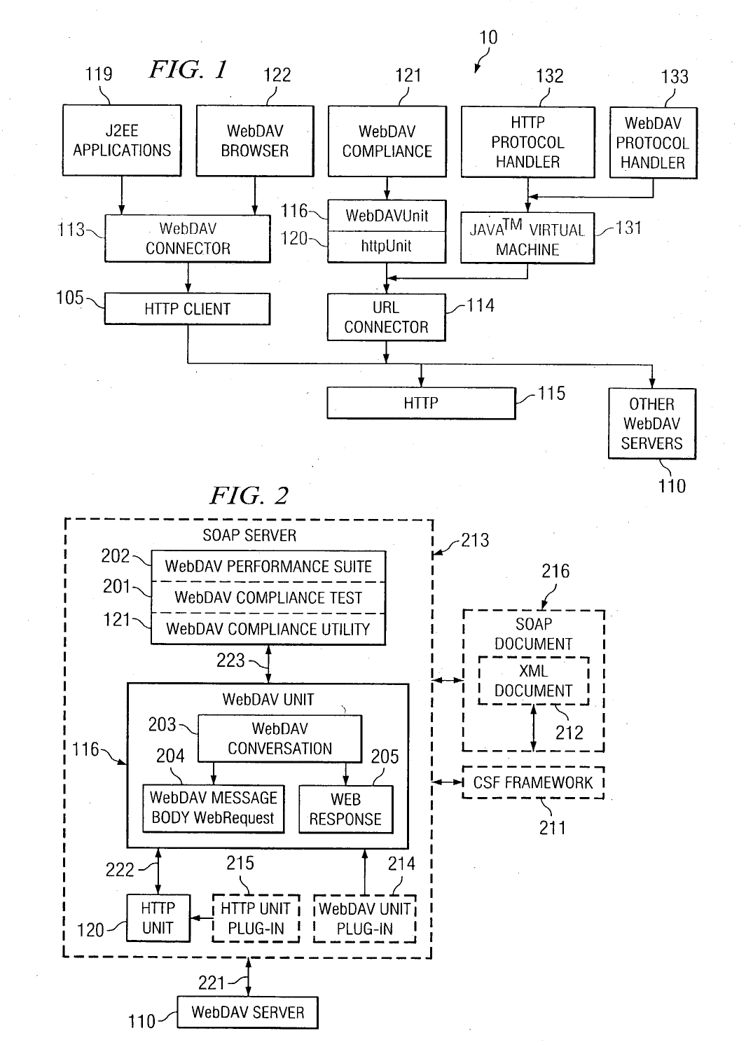

The storage abstraction architecture has produced many components which create both the abstraction for the storage system and a usable storage infrastructure upon which systems are created. While much of the storage abstraction is viewed as a server side layer, there are many layers of connectivity into such a layer. FIG. 1 is a block diagram illustrating an overview of WebDAV system architecture 10 according to the present embodiments, which includes storage abstraction and system as well as mechanisms for connecting, previewing, and testing such systems.

The storage abstraction architecture has produced many components which create both the abstraction for the storage system and a usable storage infrastructure upon which systems are created. While much of the storage abstraction is viewed as a server side layer, there are many layers of connectivity into such a layer. FIG. 1 is a partial overview block diagram illustrating various components of WebDAV system architecture 10, which includes mechanisms for connecting and testing such systems, according to the present embodiments.

WebDAV system architecture 10 comprises various components that are made available within an installation. Each component, whether for example a web application or a library, has its own description of usage and configuration.

Architecture 10 further includes WebDAV Java™ Connector Architecture (JCA) connector 113, which provides a standard client API for connecting into WebDAV server 110. JCA connector 113 utilizes HTTP client 105 for HTTP connectivity. HTTP client 105, which is outside the scope of the present disclosures, is adapted from the open source HTTP client efforts within the Apache Jakarta Commons project. The home page for Commons HTTP client is HTTP://jakarta.apache.org/commons/HTTPclient/. HTTP URL connector 114, which extends the common Java™ Development Kit (JDK) version, is provided to upgrade prior art HTTP URL connector 115, which does not presently support the needed WebDAV methods.

It is further advantageous in WebDAV architecture 10 to access any WebDAV server 110 and/or any non-relational data sources from a WebDAV browser, for example WebDAV browser 122, and/or from a J2EE application, for example J2EE application 119, via a WebDAV-compliant connector that conforms to Java™ Connector Architecture (JCA), depicted as WebDAV connector 113.

WebDAV Protocol Handler 133 is a low-level component that allows an application to have a raw WebDAV conversation with a WebDAV server, for example WebDAV server 110. According to some embodiments, JAVA™ Virtual Machine (JVM) 131 is configured to use WebDAV Protocol Handler 133 instead of traditional HTTP protocol handler 132 for HTTP requests by setting the system property java.protocol.handler.pkgs to com.hp.mw.richmedia.webdav.protocol. Any subsequent HTTP URL requests are then resolved using WebDAV Protocol Handler 133. After configuring WebDAV Protocol Handler 133 for use on HTTP connections, WebDAV Protocol Handler 133 utilizes the URL openConnection( ) mechanism for a subsequent HTTP URL request. When JAVA™ Virtual Machine (JVM) 131 is configured to use traditional HTTP protocol handler 132 for HTTP requests, however, HTTP URL requests are not WebDAV compliant.

WebDAV Unit 116 was built as an adaptation of traditional HTTP Unit 120 web testing framework. WebDAV Unit 116 aims to simplify the creation of WebDAV unit tests. WebDAV Unit 116 is a unit testing framework extending open source HTTP Unit framework 120, allowing unit testing of WebDAV application and server implementations employing WebDAV Compliance utility 121. In the context of the present disclosure, a unit test is a test of one application to see if remediation efforts were successful. The unit test does not generally test how well the tested application will work in an interaction with other applications. Thus, a unit test is an invocation that tests a definable and confined unit. For example, testing a WebDAV method is a unit test. Advantageously, WebDAV Unit 116 allows WebDAV servers 110 to be tested via a simple API and allows automated testing of WebDAV servers 110. A test suite is created to invoke test operations against a WebDAV server, simulating what real users might or might not do in an environment in which a user could invoke many links and directions.

FIG. 2 is a more detailed schematic block diagram illustrating the relationships between WebDAV Unit framework 116, HTTP Unit framework 120, WebDAV Compliance utility 121, and WebDAV server 110 through links 221, 222, and 223 within WebDAV system architecture 10 in accordance with one embodiment. Links 221, 222, and 223 can be although need not be physical links, and can be any sort of hardware or software communication links in a network. In accordance with the present embodiment, WebDAV Unit 116 comprises three main objects, namely WebDAVConversation 203, WebDAVMessageBodyWebRequest 204, and WebResponse 205. WebDAVConversation 203 holds the context for a series of WebDAV requests. It manages cookies used to maintain session context, computes relative URLs and generally emulates client behavior needed to build an automated test of a WebDAV server. WebDAVMessageBodyWebRequest 204 class is the base class for all WebDAV requests. It holds the contents of a request including the WebDAV method, header information, and the body of the request. WebResponse 205 class represents the response of a standard HTTP or WebDAV request. It contains response headers as well as response data.

In some embodiments, unit testing is run in a service oriented architecture, for example Core Services Framework (CSF) 211. CSF 211 is a services-based container in WebDAV architecture 10, which allows disparate services to interact with one another. Applications are built by deploying the services needed by the application. In some embodiments, WebDAV Unit 116 is implemented as a CSF service. Advantageously, this allows WebDAV Unit 116 to be controlled by CSF framework 211 and allows easy integration with applications that require it. Similarly, in some embodiments HTTP Unit framework 120 is implemented as a CSF service, such that HTTP Unit 120 is controlled advantageously by CSF framework 211, allowing easy integration with applications that require it.

WebDAV Compliance utility 121 built upon WebDAV Unit is the beginning of a test suite, for example WebDAV Compliance Suite 201 and/or WebDAV Performance Suite 202, which are each a set of WebDAV unit tests (a suite) that provide information about their respective topic. For example, a WebDAV Compliance Test is a unit test used to confirm if a WebDAV server, for example WebDAV server 110, is compliant with the WebDAV standard. WebDAV Compliance Suite 201 provides a complete set of tests that would validate if a WebDAV server as complying with the WebDAV specification (RFC2518). Similarly, a WebDAV Performance test is a unit test used to guarantee that a WebDAV server delivers a specific performance, for example a specific response time, in response to the specific unit test. A WebDAV Performance Test measures a product's efficiency or performance while it is running, and is thus more subjective than a WebDAV compliance test. WebDAV Performance Suite 202 comprises a group of tests that measure a product's performance in different WebDAV contexts.

In some embodiments, an eXtensible Markup Language (XML) document 212 can be used to drive and define the tests that are run by WebDAV Unit 116. Advantageously, by using XML to define the tests, no code needs to be written to add new tests or to modify existing tests, whereas traditional methods require the writing of code for each WebDAV Unit test that is performed. This greatly reduces the programming sophistication required of the person routinely writing or modifying the tests.

In some embodiments, WebDAV Compliance Test 201 and/or WebDAV Performance Suite 202 is implemented as a web service, advantageously allowing WebDAV Compliance Test 201 to be accessed and used like other web services. In some embodiments, WebDAV Performance Suite 202 is offered as a web service via Simple Object Access Protocol (SOAP), an existing technology that is used to access web services. Defining a SOAP envelope 213 for WebDAV Performance Suite 202 allows it to be accessed via SOAP.

To drive WebDAV Compliance Test 201 and WebDAV Performance Suite 202 unit tests as XML documents, thereby exposing WebDAV test suites 201, 202 (or WebDAV unit in general) as a web service, XML Document 212 is wrapped in a SOAP Envelope, for example SOAP Document 216. This is accomplished in accordance with conventional practice by embedding XML Document 212 in SOAP Document 216. Similarly, XML driven WebDAV Unit 116 is embedded in SOAP server 213 and connected via WebDAV Unit plug-in mechanism 214 provided by SOAP server 213. In some embodiments, SOAP server 213 alternatively or additionally wraps HTTP Unit 120, thereby allowing HTTP unit testing to be driven as a web service by XML document 212.

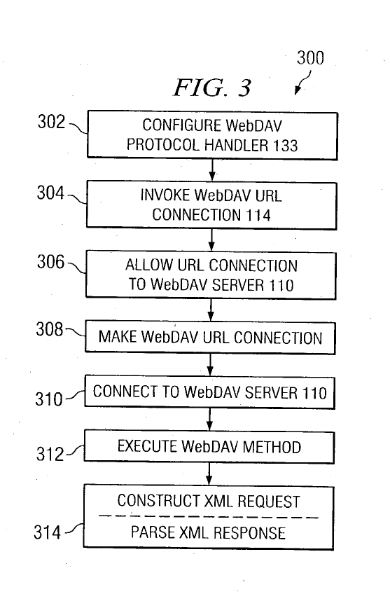

Referring again to FIG. 1, WebDAV Protocol Handler 133 is a low-level component that allows an application to have a raw WebDAV conversation with a server 110. In a raw WebDAV conversation, a protocol handler and connection are mechanisms which assist in creating a connection with a WebDAV server, e.g., server 110, and then conversing with the WebDAV server via its known protocol. FIG. 3 is a flow diagram 300 depicting the deployment of WebDAV URL Connection 114 using WebDAV Protocol Handler 133, according to some embodiments. At step 302, JAVA™ Virtual Machine (JVM) 131 is configured to use WebDAV Protocol Handler 133 (instead of traditional HTTP protocol handler 132) for HTTP requests by setting the system property java.protocol.handler.pkgs to WebDAV Protocol Handler, for example Protocol Handler 133. Any subsequent HTTP URL requests are then resolved using WebDAV Protocol Handler 133. After configuring WebDAV Protocol Handler 133 for use on HTTP connections, WebDAV Protocol Handler 133 utilizes the URL openConnection( ) mechanism for a subsequent HTTP URL request.

To support WebDAV-specific methods over HTTP, at step 304 WebDAV Protocol Handler 133 invokes WebDAV URL Connection 114, which at step 306 allows URL connections to be made to WebDAV servers 110 using the conventional URL.getConnection( ) API, where the API acronym stands for Application Programming Interface. When WebDAV URL Connection 114 is invoked using the openConnection( ) method on a URL, any HTTP URL request will result in a WebDAV URL Connection 114 being made at step 308 instead of the conventional HTTP URL Connection. WebDAV URL Connection 114 provides a URL connection object allowing clients at step 310 to connect to WebDAV servers 110. It also allows clients using the connection at step 312 to execute WebDAV methods. In some embodiments, at step 314 an application using WebDAV Protocol Handler 133 advantageously constructs valid XML requests and parses XML responses from WebDAV Server 110.

This mechanism allows WebDAV-specific methods to be transported and executed over the HTTP channel. No other higher-level handling is typically provided. Although commercial manufacturers, for example Sun Microsystems, provide prior art HTTP URL Connections, these implementations do not allow WebDAV methods to be executed.

APPENDIX A below illustrates sample code for getting a directory listing from a WebDAV collection.

### APPENDIX A: SAMPLE CODE

### Note that Comments are Embedded in the Code Using the Java™ Comment Style of ‘//Comment’.

The following sample code illustrates how to get a directory listing from a WebDAV collection. The program takes one or three arguments. With one argument, it connects to the URL specified on the command line and lists children of the collection. With three arguments, the first argument is the URL, and arguments two and three are the username and password to use with basic authentication.

```
// import needed packages to executed code
import sun.misc.BASE64Encoder;
// import needed xml utilities and standards
import org.xml.sax.*;
import org.xml.sax.helpers.DefaultHandler;
import javax.xml.parsers.*;
// import needed standard java packages
import java.net.URL;
import java.util.Properties;
import java.io.*;
public class SampleDir
{
  public static void main ( String args [] )
  {
    try
    {
      // Set the package handler to the webdav protocol handler
      Properties props = System.getProperties( );
      props.put (“java.protocol.handler.pkgs”,
“com.hp.mw.richmedia.webdav.protocol”);
      // encode the username/password pair
      String authorization = null;
      if ( args.length == 3 )
      {
        BASE64Encoder b64encoder = new BASE64Encoder ( );
        String username = args [1];
        String password = args [2];
        authorization = b64encoder.encode ( (username + “:” +
        password).
getBytes ( ) );
      }
      // Create the Url connection to the desired URL.
      final URL Url = new URL ( args [0] );
      WebDAVURL Connection urlc = (WebDAVURLConnection)
url.openConnection ( );
      // set the webdav method, inputs and properties.
      urlc.setRequestMethod ( “PROPFIND” );
      urlc.setDoInput ( true );
      urlc.setDoOutput ( true );
      if ( authorization ! = null )
      {
        urlc.setRequestProperty ( “authorization”, “Basic ” +
        authorization
);
      }
      urlc.setRequestProperty ( “content-type”,
      “text/xml; charset=utf-8”);
      urlc.setRequestProperty ( “depth”, “1” );
      // send the request
      PrintStream os = new PrintStream ( urlc.getOutputStream( ) );
      String request =
        “<?xml version=\“1.0\” encoding=\“utf-8\”?>” +
        “<propfind xmlns=\“DAV: \”>” +
        “<prop><resourcetype/><displayname/></prop>” +
        “</propfind>\r\n”;
      os.write ( request.getBytes ( “UTF-8”));
      // Get the response from the webdav server
      InputStream is = urlc.getInputStream ( );
      SAXParserFactory parserFactory =
      SAXParserFactory.newInstance ( );
      parserFactory.setNamespaceAware ( true );
      parserFactory.setValidating ( false );
      // using an anonymous class parse and print the results.
      SAXParser parser = parserFactory.newSAXParser ( );
      XMLReader reader = parser.getXMLReader ( );
      reader.setContentHandler ( new DefaultHandler ( )
      {
        private String m_node;
        private final String m_href = url.getPath( );
        private String m_currentHref;
        public void startElement ( String namespaceURI, String
localName, String gName, Attributes attrs)
        {
          m_node = localName;
        }
        public void characters ( char characters [], int start, int length )
        {
          if ( m_node.equals ( “href”))
          {
            m_currentHref = new String ( characters, start,
length );
          }
          // Exclude “current” directory.
          if( (m_currentHref == null ∥ !m_currentHref.equals (
m_href) )&& m_node.equals ( “displayname”) )
          {
            System.out.println ( new String ( characters, start,
length) );
          }
        }
      };
      // Following line invokes the parsing of the response to occur.
      reader.parse ( new InputSource (is) );
    }
    catch ( Throwable t )
    {
      System.err.println ( t.getLocalizedMessage ( ) );
    }
  }
}
```

What is claimed is:

1. A system operable to support Web-based Distributed Authoring and Versioning (WebDAV) protocol, said system comprising:
a plurality of applications and server implementations; and
a WebDAV URL connection operable to allow at least one said application to have a raw WebDAV conversation with at least one said server over a HTTP channel.

2. The system of claim 1 further comprising a Java™ Virtual Machine (JVM) operable to use a WebDAV protocol handler for handling HTTP URL requests.

3. The system of claim 2 wherein, dependent upon the setting of a system property, said WebDAV protocol handler is operable to replace an alternative HTTP protocol handler.

4. A method for connecting a client with a WebDAV-compliant server over a HTTP channel, said method comprising:
at a Java™ Virtual Machine (JVM) configuring a WebDAV protocol handler for handling HTTP URL requests;
invoking a WebDAV URL connection;
allowing a client making a URL request to connect to a WebDAV-compliant server;
connecting said client to said WebDAV-compliant server via said WebDAV URL connection; and
allowing said connected client to execute WebDAV methods via said WebDAV URL connection.

5. The method of claim 4 wherein an application using said WebDAV protocol handler constructs valid extensible Markup Language (XML) requests to said WebDAV-compliant server.

6. The method of claim 4 wherein an application using said WebDAV protocol handler parses XML responses from said WebDAV-compliant server.

7. A system operable to support Web-based Distributed Authoring and Versioning (WebDAV) protocol, said system comprising:
at a Java™ Virtual Machine (JVM) means for configuring a WebDAV protocol handler for handling HTTP URL requests;
means for invoking a WebDAV URL connection;
means for allowing a client making a URL request to connect to a WebDAV-compliant server;
means for connecting said client to said WebDAV-compliant server via said WebDAV URL connection; and
means for allowing said connected client to execute WebDAV methods via said WebDAV URL connection.

8. The system of claim 7 comprising means for constructing valid eXtensible Markup Language (XML) requests to said WebDAV-compliant server via an application using said WebDAV protocol handler.

9. The system of claim 7 comprising means for parsing XML responses from said WebDAV-compliant server via an application using said WebDAV protocol handler.

10. Computer-executable software code stored to a computer-readable medium, said computer-executable software code comprising:
code for configuring a WebDAV protocol handler for handling HTTP URL requests;
code for invoking a WebDAV URL connection;
code for allowing a client making a URL request to connect to a WebDAV-compliant server;
code for connecting said client to said WebDAV-compliant server via said WebDAV URL connection; and
code for allowing said connected client to execute WebDAV methods via said WebDAV URL connection.

11. The computer-executable software code of claim 10 comprising code for constructing valid eXtensible Markup Language (XML) requests to said WebDAV-compliant server via an application using said WebDAV protocol handler.

12. The computer-executable software code of claim 10 comprising code for parsing XML responses from said WebDAV-compliant server via an application using said WebDAV protocol handler.

13. The computer-executable software code of claim 10, wherein said code for configuring a WebDAV protocol handler for handling HTTP URL requests is executable at a Java™ Virtual Machine (JVM).
